(19) United States
(12) Patent Application Publication
(10) Pub. No.: US 2013/0178767 A1
(43) Pub. Date: Jul. 11, 2013

(54) PHYSICAL THERAPY SUPPORT DEVICE

(71) Applicant: Edward Ronald Dreske, Las Vegas, NV (US)

(72) Inventor: Edward Ronald Dreske, Las Vegas, NV (US)

(73) Assignee: RETRAINER INC., Las Vegas, NV (US)

(21) Appl. No.: 13/345,020

(22) Filed: Jan. 6, 2012

(51) Int. Cl. A61H 1/02

(52) U.S. Cl. 601/23

(57) ABSTRACT

A physical therapy support device. The device includes a framework sized for surrounding a user. The framework has a frame and legs extending downward from the frame to casters positioned at lower ends of the legs. The support device also includes a harness assembly attached to the frame for suspending a user in the framework. The harness assembly includes a leg loop sized for surrounding a leg of the user and a suspender connected to the leg loop and the frame for suspending the leg loop from the framework to suspend the user inside the framework.

### BACKGROUND

The present invention generally relates to physical therapy support devices, and more particularly to a physical therapy support devices having a mobile framework and harness assembly.

Physical therapy is useful to rehabilitate patients and allow them to recover capability after injury and/or surgery. When a patient is unable to walk or stand upright, attendants are needed to support the patient during therapy or between therapy stations. These attendants may be diverted from other duties, potentially reducing patient care. Even if the attendants are not diverted from other duties, they must be paid, increasing the cost of therapy. Thus, there is a need for a device capable of supporting patients during therapies and between therapy stations to eliminate or reduce attendants needed during physical therapy.

### SUMMARY

In one aspect, the present disclosure includes a physical therapy support device, comprising a framework sized for surrounding a user. The framework has a frame and a plurality of legs extending downward from the frame to casters positioned at lower ends of the legs. The support device also includes a harness assembly attached to the frame for suspending a user in the framework. The harness assembly includes a leg loop sized for surrounding a leg of the user and a suspender connected to the leg loop and the frame for suspending the leg loop from the framework to suspend the user inside the framework.

In another aspect, the present disclosure includes a physical therapy support device, comprising a framework sized for surrounding a user. The framework has a frame and a plurality of legs extending downward from the frame to casters positioned at lower ends of the legs. In addition, the support device includes a harness assembly attached to the frame for suspending a user in the framework. The harness assembly includes a torso support for surrounding a torso of the user and a suspender connected to the torso support and the frame for suspending the torso support from the frame to suspend the user inside the framework.

In yet another aspect, the present disclosure includes a physical therapy support device. The device comprises a framework sized for at least partially surrounding a user. The framework has a rectilinear upper frame member, a rectilinear mid frame member connected to the upper frame member, and a plurality of legs extending downward from the mid frame member to casters positioned at lower ends of the legs. The device further comprises a harness assembly attached to the upper frame member for suspending a user in the framework. The harness assembly includes a user attachment for supporting a user. The user attachment has a leg loop sized for surrounding the leg of a user and a torso support connected to the leg loop for surrounding the torso of a user. The harness assembly also includes a suspender connected to the torso support and the upper frame for suspending the torso support from the upper frame member to suspend the user inside the framework.

Other aspects of the present disclosure will be apparent in view of the following description and claims.

### BRIEF DESCRIPTION OF THE DRAWINGS

FIG. 1 is a perspective of one embodiment of a physical therapy support device of the present invention;

FIG. 2 is a perspective of a framework of the physical therapy support device of FIG. 1;

FIG. 3 is a front elevation of the framework of FIG. 2;

FIG. 4 is a right side elevation of the framework of FIG. 2;

FIG. 5 is a detail perspective illustrating a height adjuster mechanism;

FIG. 6 is a perspective similar to FIG. 2 but having a hand support and forearm supports;

FIG. 7 is a detail perspective illustrating the hand support;

FIG. 8 is a detail perspective illustrating the forearm supports;

FIG. 9 is a perspective similar to FIG. 2 but having an attached removable seat;

FIG. 10 is another perspective showing the removable seat;

FIG. 11 is a perspective of a first embodiment of a harness assembly;

FIG. 12 is another perspective of the harness assembly of FIG. 11;

FIG. 13 is a perspective of a second embodiment of a harness assembly;

FIG. 14 is a perspective of a third embodiment of a harness assembly; and

FIG. 15 is a perspective of a physical therapy support device of a second embodiment of the present invention.

Corresponding reference characters indicate corresponding parts throughout the drawings.

### DETAILED DESCRIPTION

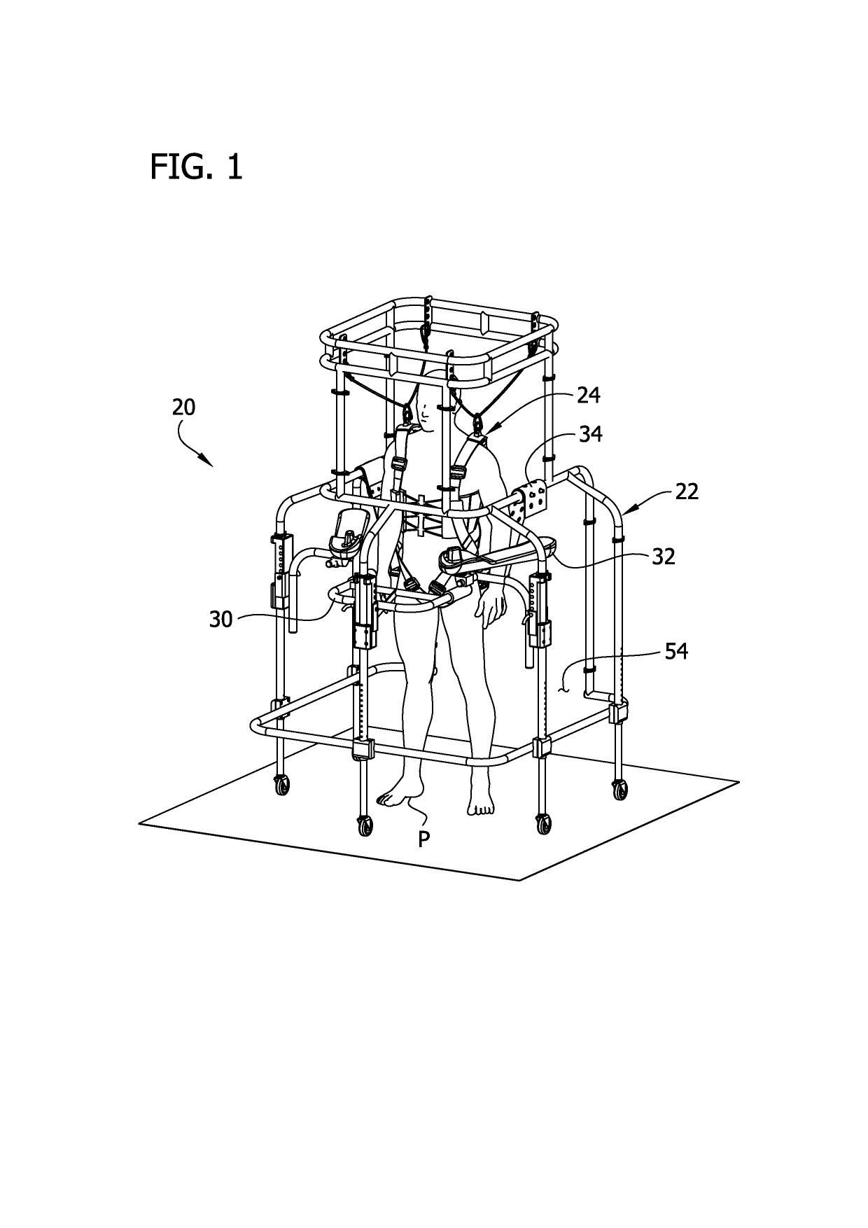

Referring to FIG. 1, a physical therapy support device incorporating a first embodiment of the present invention is designated in its entirety by the reference number 20. The support device 20 generally includes a portable scaffold or framework, generally designated by 22, sized for surrounding a user or patient P and a harness assembly, generally designated by 24, for supporting a user while undergoing physical therapy. The harness assembly 24 suspends the user from the framework 22. Certain auxiliary accessories used in combination with the support device 20 are also shown in FIG. 1. These accessories include a hand support 30, forearm supports 32, and a seat 34.

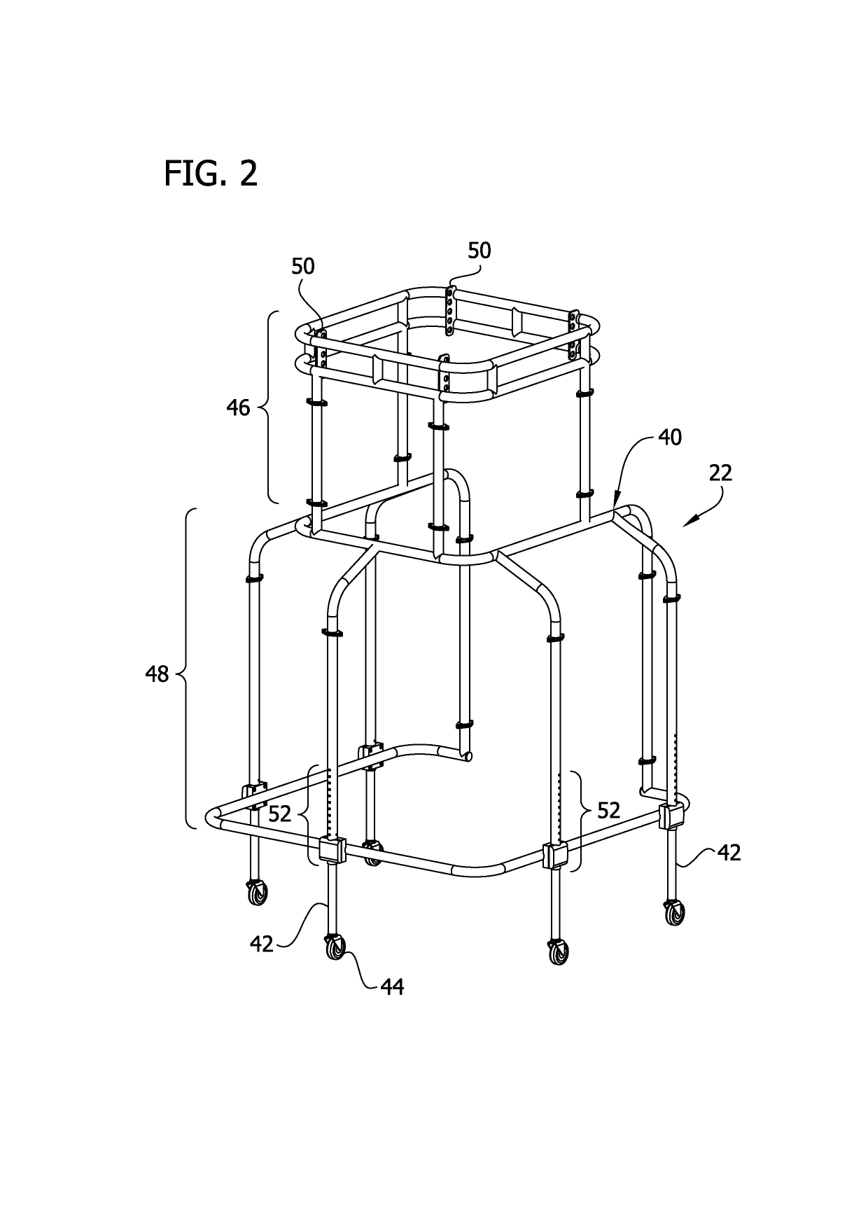

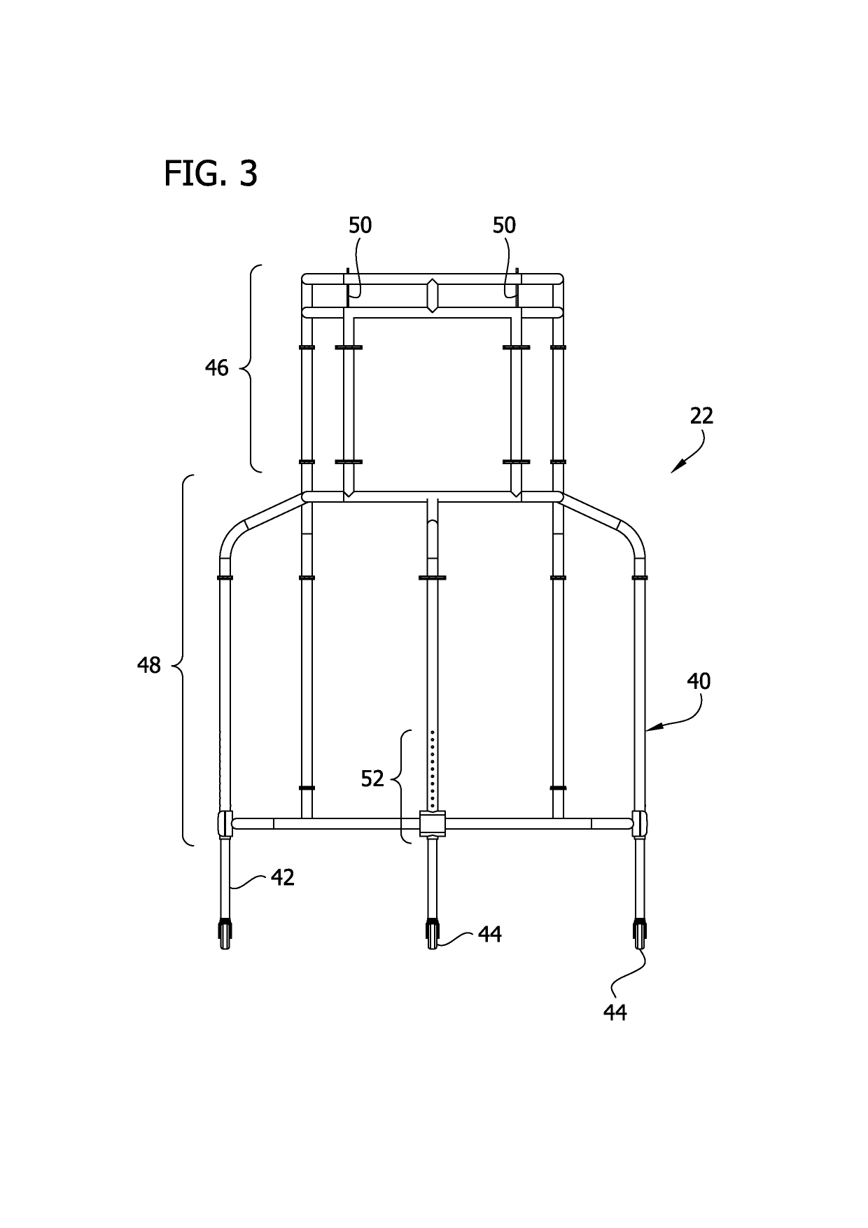

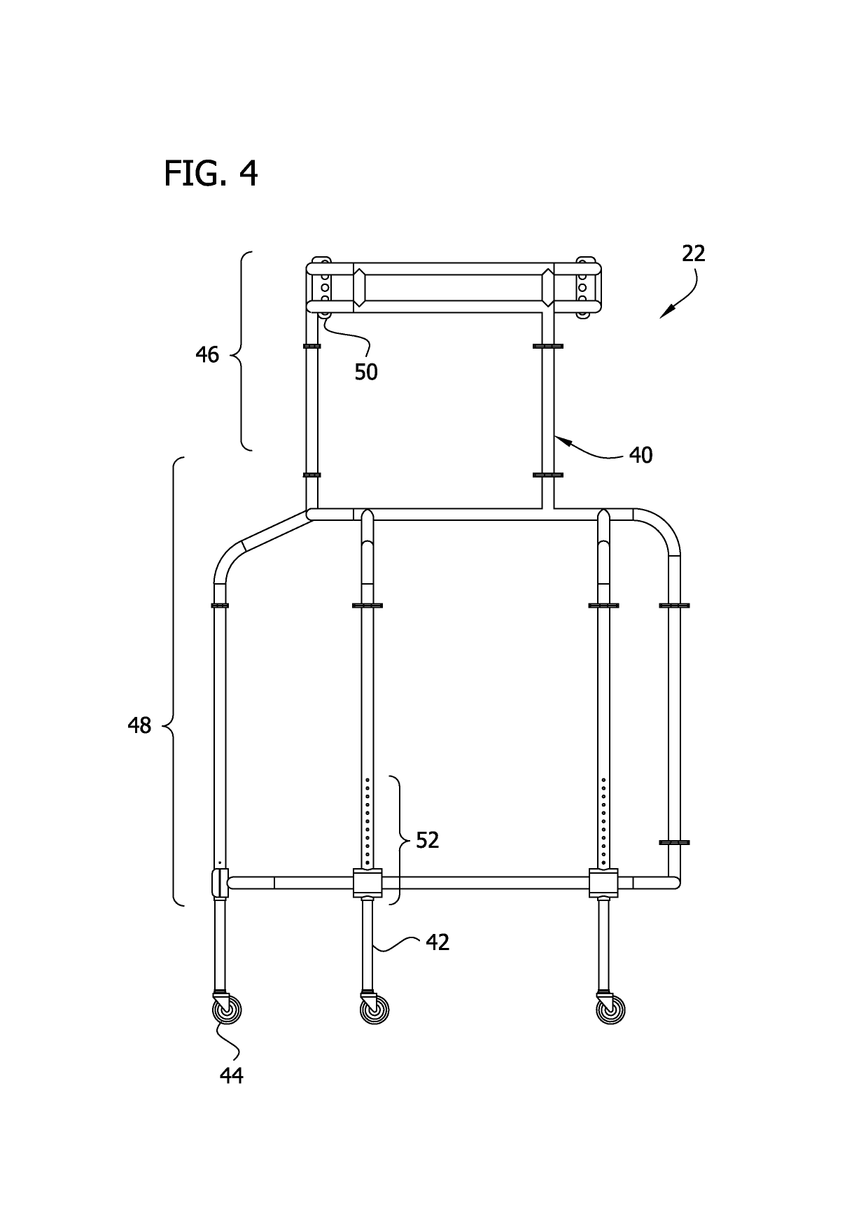

As shown in FIGS. 2-4, the framework 22 includes a frame, generally designated by 40, connected to selectively extendable legs 42. The legs 42 extend downward from the frame 40 to casters 44 that permit the framework 22 to move freely about. The frame 40 is an assembly of an upper frame sub-assembly or member, generally designated by 46, and a mid frame sub-assembly or member, generally designated by 48. The upper frame member 46 includes four anchor brackets 50 to which the harness assembly 24 (FIG. 1) is attached. Although the framework 22 may have other numbers of legs without departing from the scope of the present invention, five legs 42 are connected to the mid frame member 48 by height adjuster mechanisms, generally designated by 52. Although the framework 22 may be made of other materials without departing from the scope of the present invention, in one embodiment the framework 22 is made of cylindrical aluminum tubing. Preferably, the materials used to make the framework 22 are sufficiently strong to support a user and sufficiently light to permit the user to easily move the framework. As will be appreciated by those skilled in the art, in the illustrated embodiment the tubing is cut into desired lengths, bent to shape, and welded together to form parts that are connected by screw fasteners to form the framework 22. Because the parts are connected by screw fasteners, the framework 22 may be disassembled for shipment and storage.

As shown in FIG. 1, the framework 22 includes an opening 54 at a rearward side, permitting a user to enter the framework. The user can either enter the framework 22 in a standing position by walking into the framework or the framework can be wheeled around the user while standing or sitting.

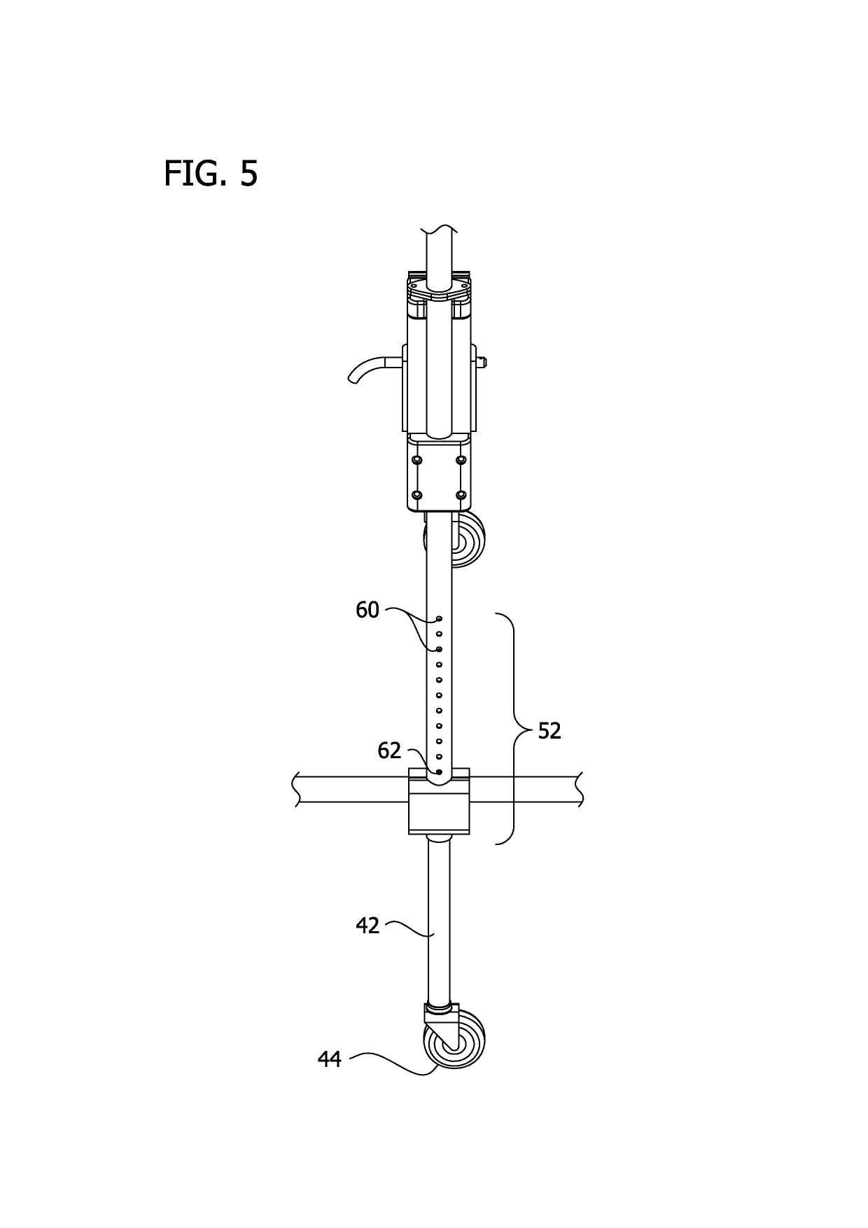

As shown in FIG. 5, the legs 42 are telescopically received in vertical tubing forming lower ends of the mid frame member 48 (FIG. 2). The tubing at the lower ends of the mid frame member 48 has a series of evenly spaced holes 60 extending upward along an outward facing side of the tubing. Although the holes 60 may be have other spacing without departing from the scope of the present invention, in one embodiment the holes are spaced at about one inch intervals. Each of the legs 42 includes a spring loaded detent 62 that engages a selected hole in the series of holes 60 to hold the leg in position. The legs 42 may be extended and retracted to raise and lower the framework 22, respectively, to change a height of the upper frame member 46 and thereby adjust the framework 22 to accommodate different sized users. As will be appreciated by those skilled in the art, the legs 42 are extended or retracted by pushing the detent 62 to disengage it from the corresponding hole 60 while moving the leg to align the detent with another hole.

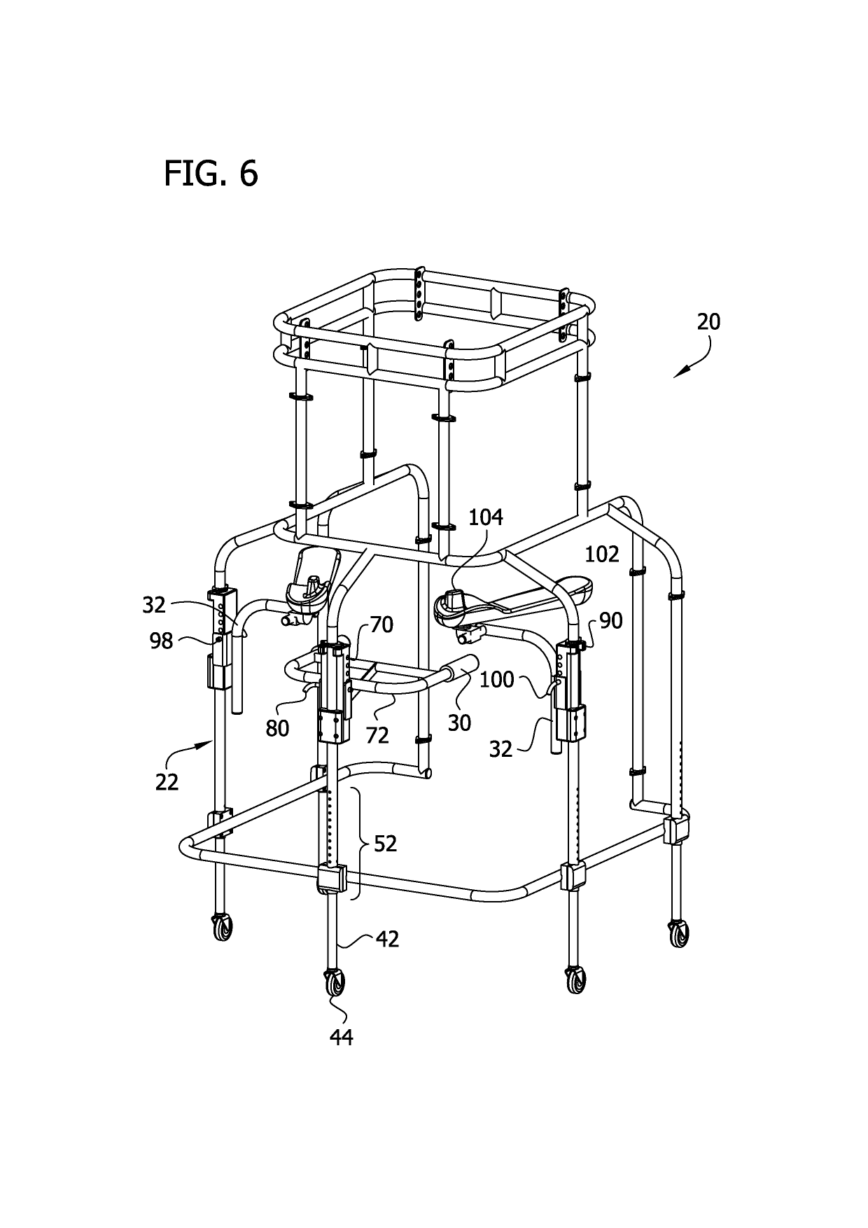

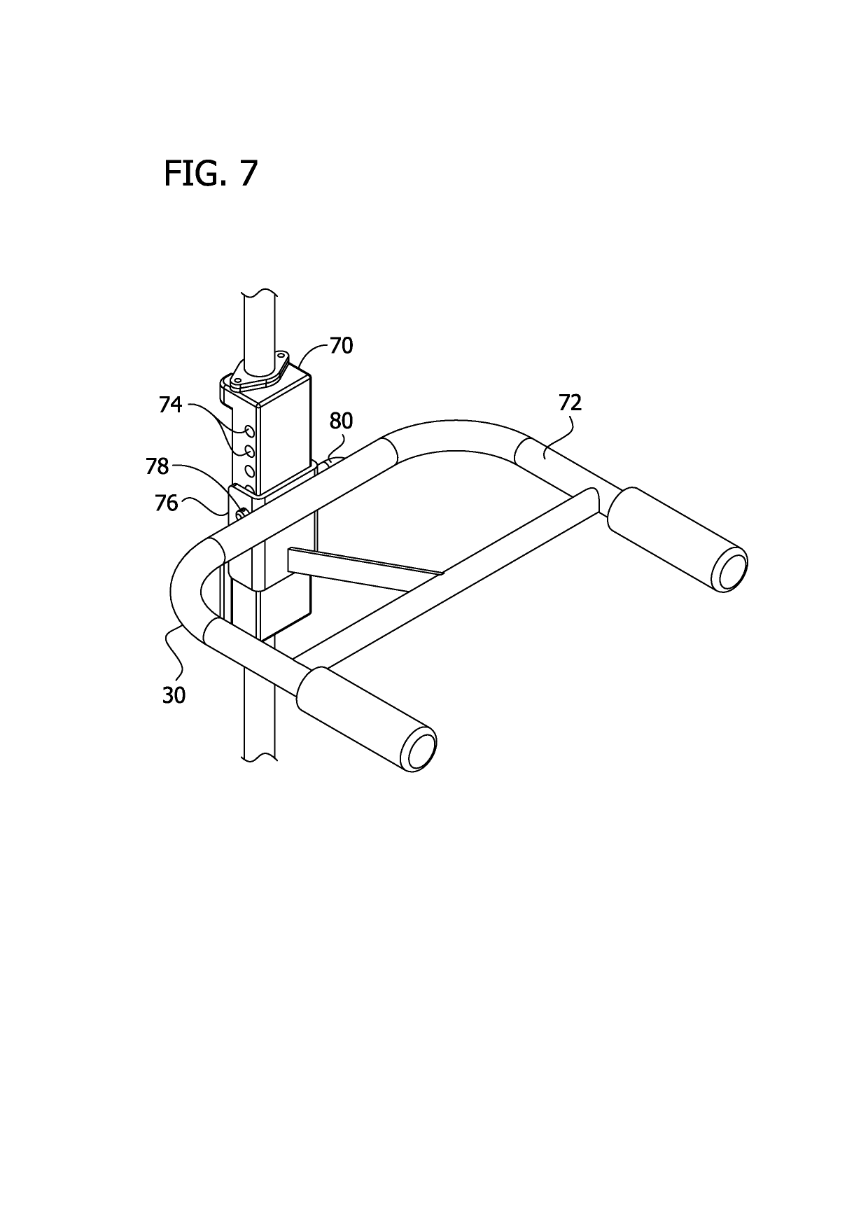

FIGS. 6 and 7 depict the framework 22 having the hand support 30, which provides hand grips similar to those found on a conventional walker to permit the user to support at least a portion of the user's weight on the hand support or to move the framework 22 into a desired position and from station to station. As further illustrated in FIG. 7, the hand support 30 includes a mount 70 attached to mid frame member 48 and a handlebar 72 releasably attached to the mount. The mount 70 includes a rectangular section having a series of vertically spaced holes 74, each of which extend horizontally through the mount. The handlebar 72 has a clevis 76 sized to receive the rectangular section of the mount 70 so that opposing openings 78 in the clevis are aligned with one of the vertically spaced holes 74 in the mount. A pin 80 is inserted through the opposing openings 78 and corresponding hole 74 to hold the handlebar 72 in position. The series of holes 74 in the mount permit a height of the handlebar 72 to be adjusted.

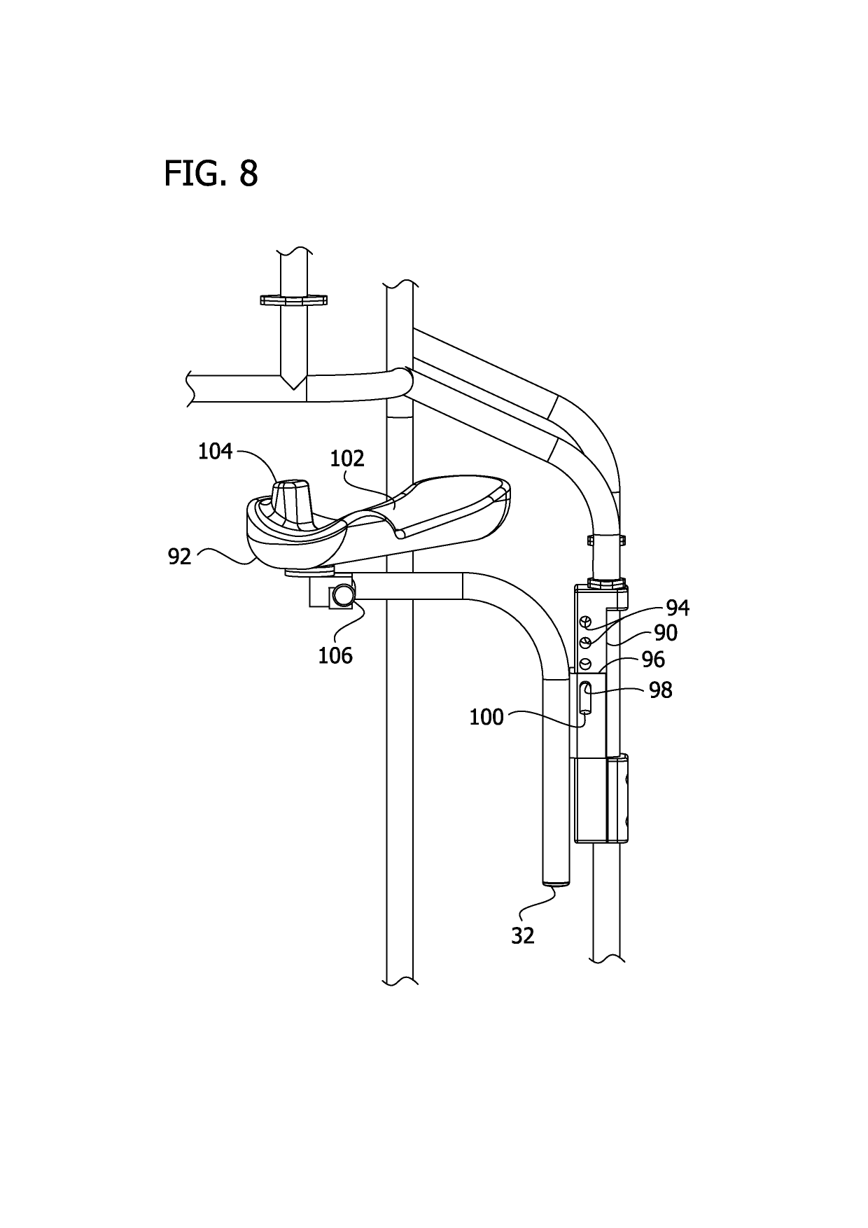

FIGS. 6 and 8 depict the framework 22 having forearm supports 32 that the user can lean on for support. As further illustrated in FIG. 8, each forearm support 32 includes a mount 90 attached to the mid frame member 48 and an armrest 92 releasably attached to the mount. The mount 90 includes a rectangular section having a series of vertically spaced holes 94, each of which extend horizontally through the mount like the handlebar mount 70. The armrest 92 has a clevis 96 sized to receive the rectangular section of the mount 90 so that opposing openings 98 in the clevis are aligned with one of the vertically spaced holes 94 in the mount. A pin 100 is inserted through the opposing openings 98 and corresponding hole 94 to hold the armrest 92 in position. The series of holes 94 in the mount 90 permits heights of the armrests 92 to be adjusted. The armrest 92 has a contoured upper surface 102 for accommodating a user's forearm and a post 104 positioned for the user to grasp. The armrest 92 is attached to an articulating joint 106 that permits the armrest to be pivot about two perpendicular axes to adjust its position.

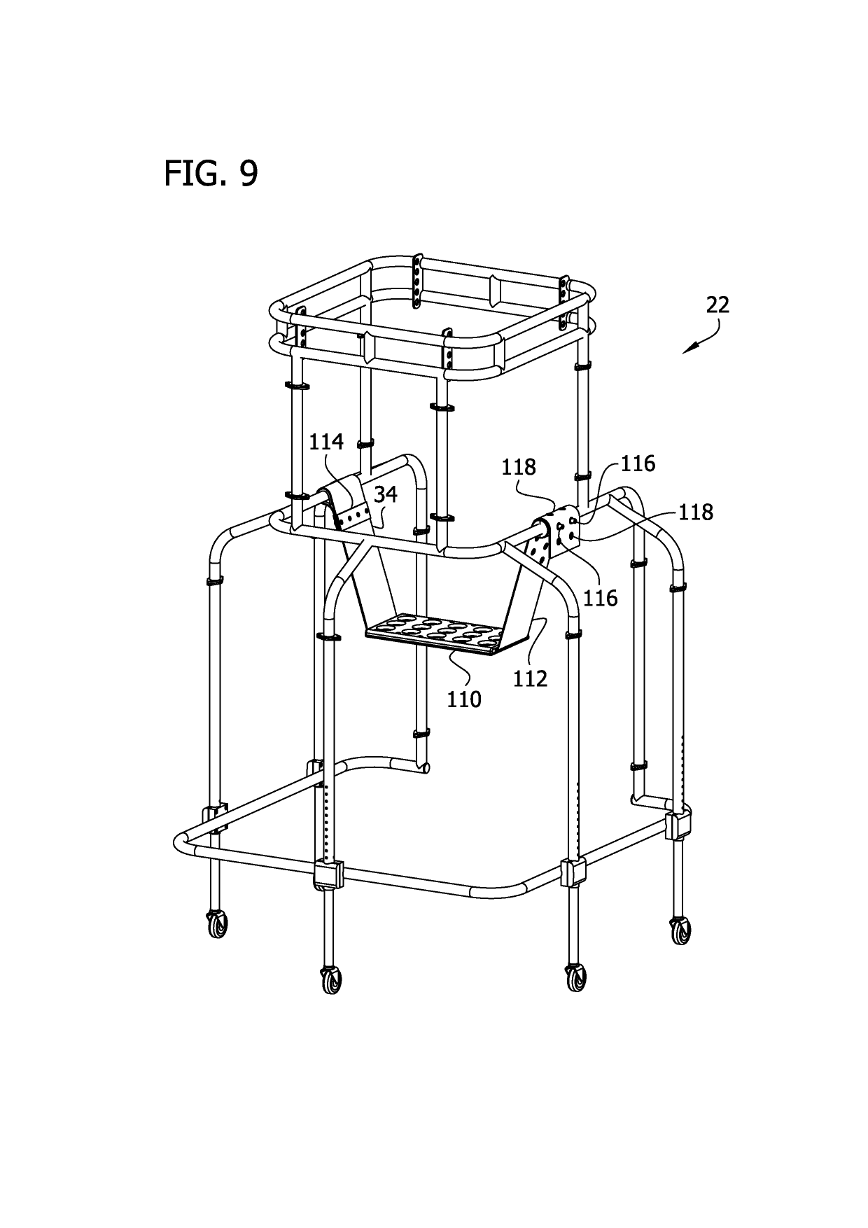

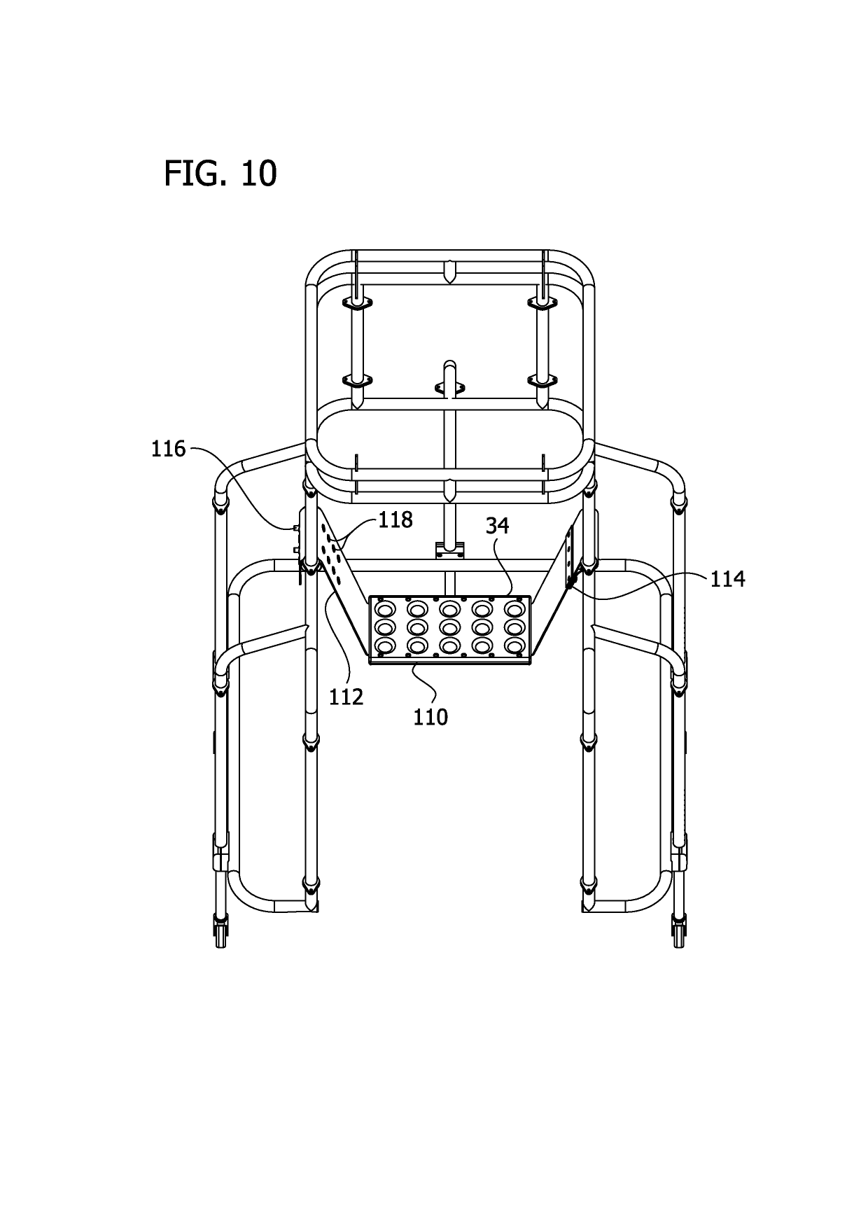

FIGS. 9 and 10 illustrate a removable seat 34 spanning the mid frame member 48 for the user to sit on such as when resting. The seat 34 includes a platform 110 slidably held on a flexible web 112 that is clamped to the mid frame member 48 at one end 114 and releasably fastened to the frame member at the other end by pins 116 inserted though two parallel series of holes 118 in the web for adjusting a height of the seat 34.

Returning to FIG. 1, the harness assembly 24 is releasably suspended from the four anchor brackets 50 of the upper frame member 46 for suspending the user in the framework 22. The harness assembly 24 may take one of several forms.

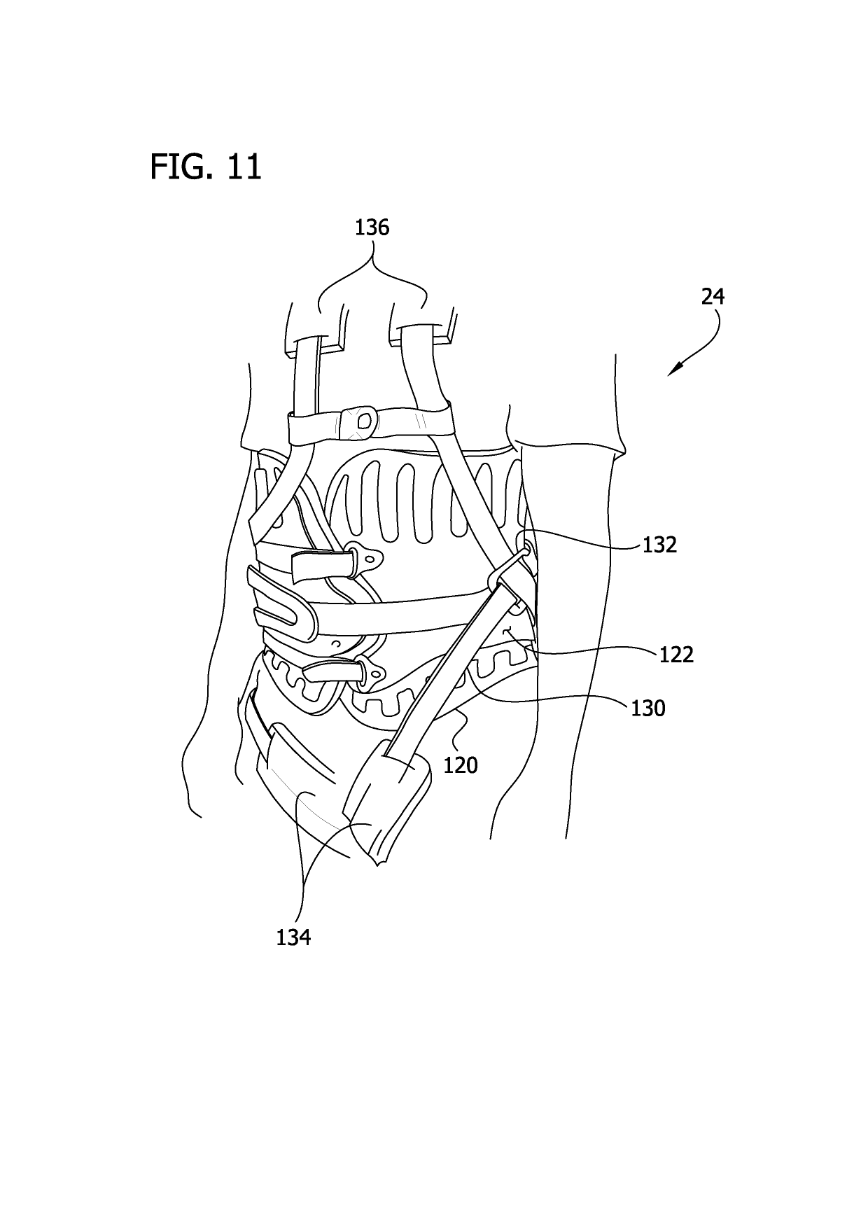

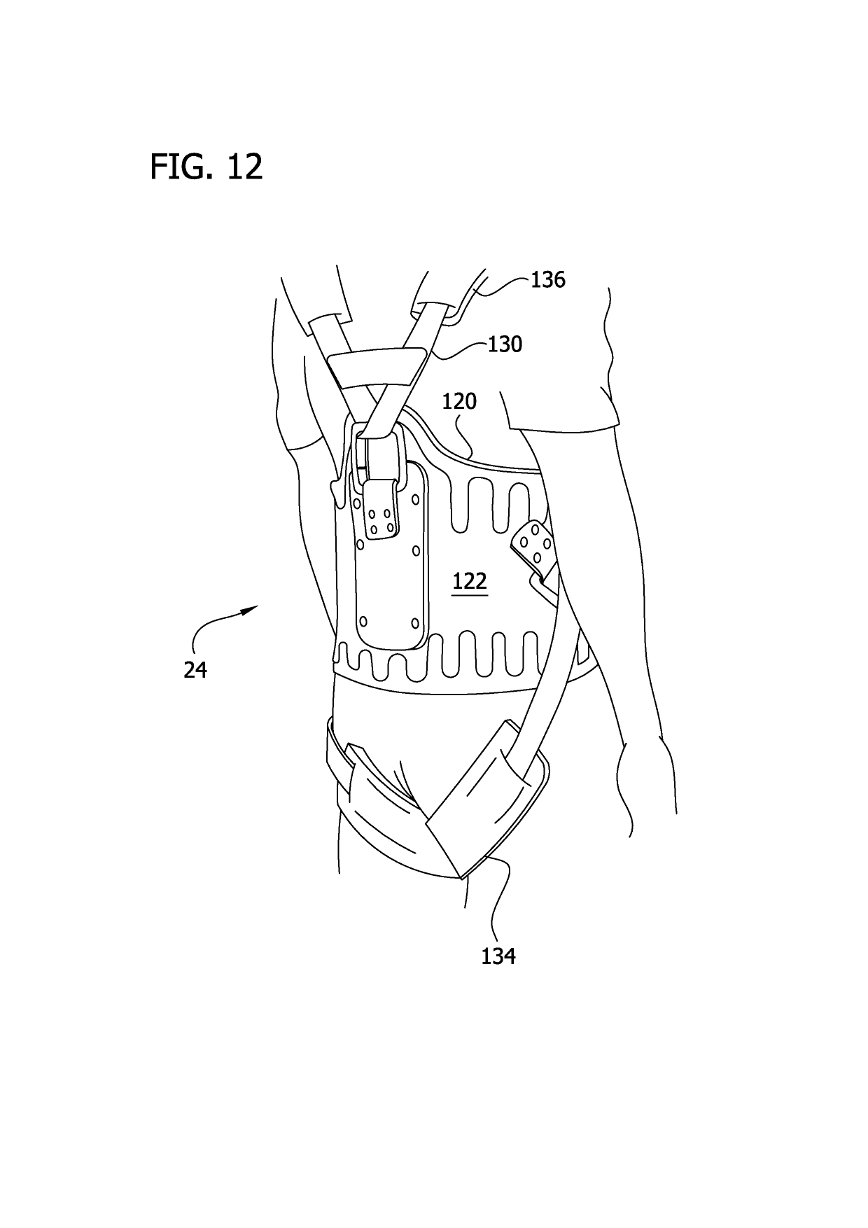

For example, as shown in FIGS. 11 and 12, the harness assembly 24 may include a truss or torso support 120 sized to encircle a user's torso. The torso support 120 is made of a flexible sheet 122 lined with foam 124. The support 120 includes straps 126 for fastening the support to the user. Webbing 130 is threaded through rings 132 on the torso support 120 to form leg loops 134 sized for receiving sand surrounding a leg of the user. The webbing 130 also extends upward from the rings 132 to form suspenders 136 that are connected to the framework 22.

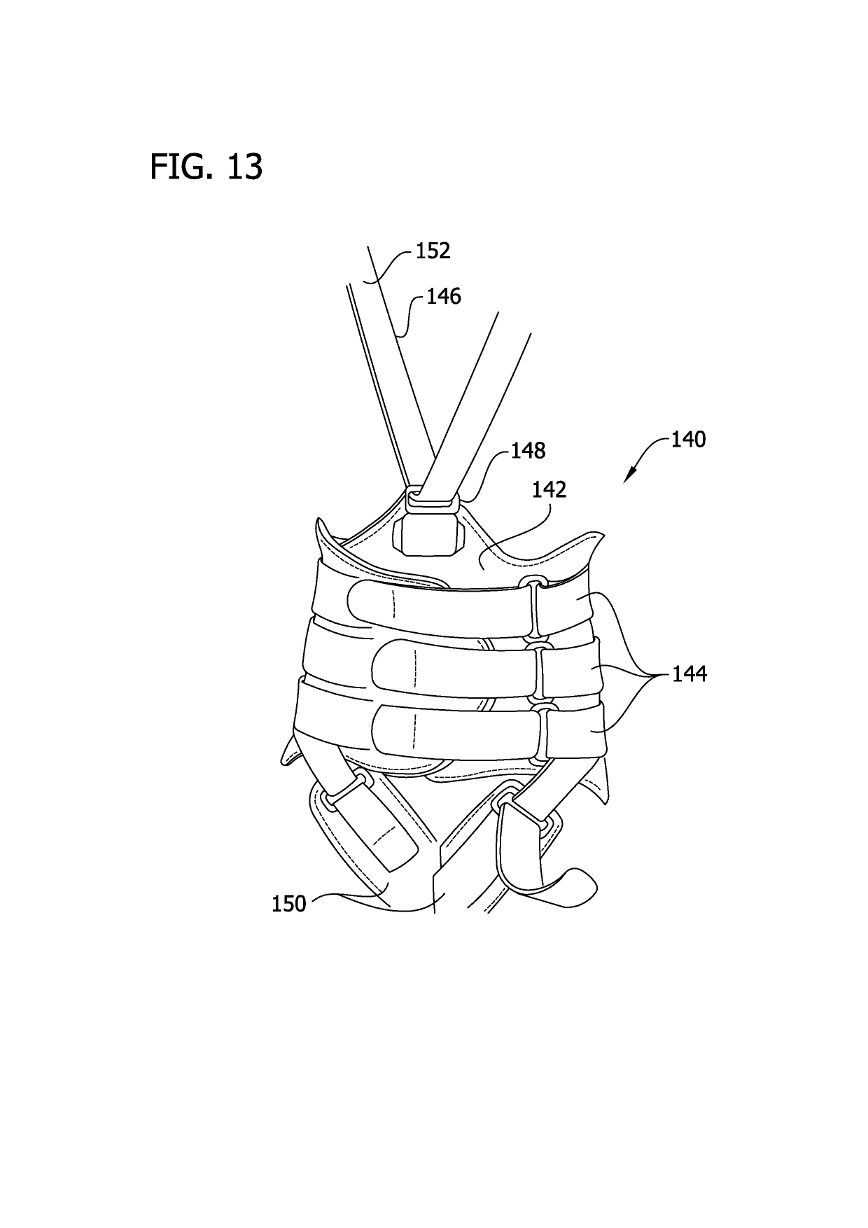

FIG. 13 illustrates a second embodiment of the harness assembly, generally designated by 140 having a flexible torso support 142 made of a canvas material fastened around the user by belts 144 having hook and loop closures. As with the assembly 24 of the first embodiment, webbing 146 threaded through rings 148 on the support 142 form leg loops 150 and suspenders 152 that connect to the framework 22.

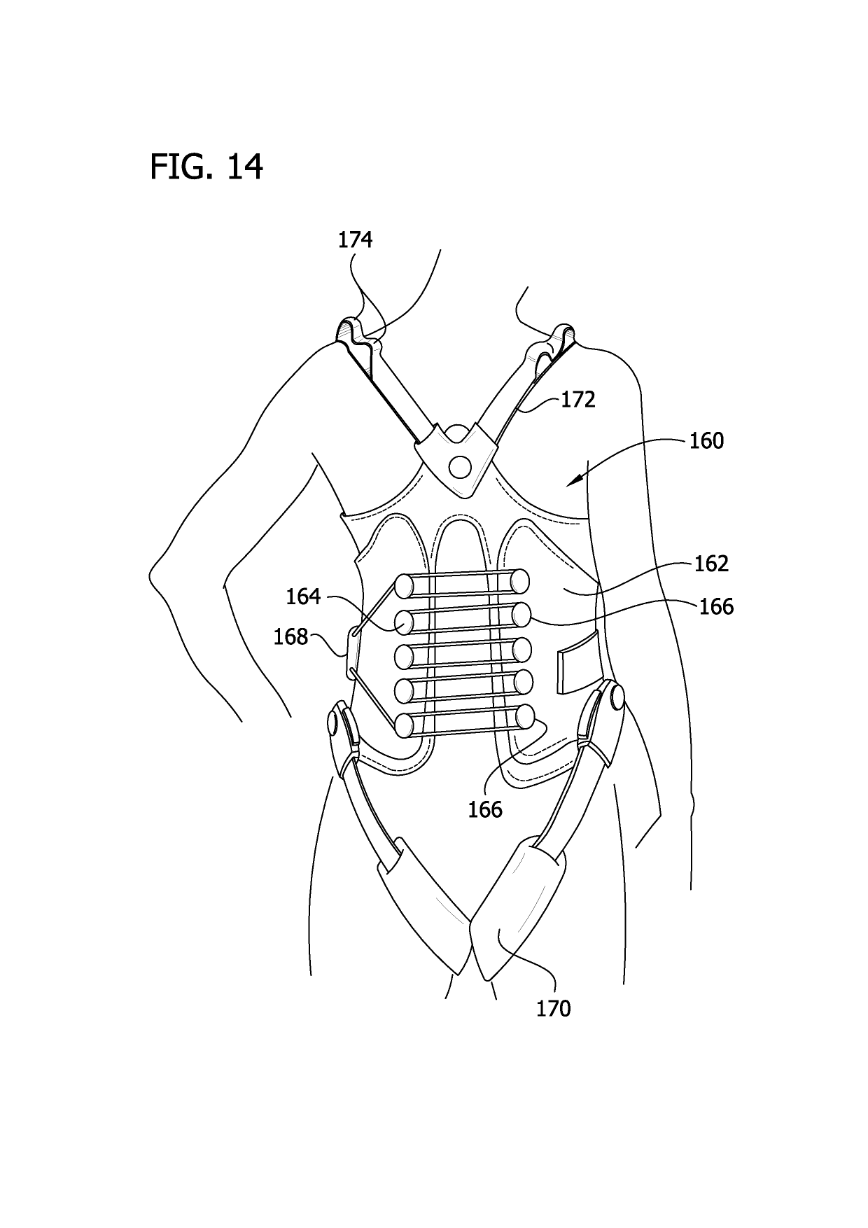

FIG. 14 illustrates a third embodiment of the harness assembly, generally designated by 160 having a flexible torso support 162 including a tensioned cord 164 wrapped around posts 166 on the support. The cord 164 is tightened around an adjustment reel 168 for adjusting the fit of the support on the user. Leg loops 170 extend downward from the support 162 and shoulder straps 172 extend upward from the support. The shoulder straps 172 have loops 174 for attaching the straps to separate suspenders (not shown) that are connected to the framework 22. In some embodiments, the suspenders have adjustable lengths.

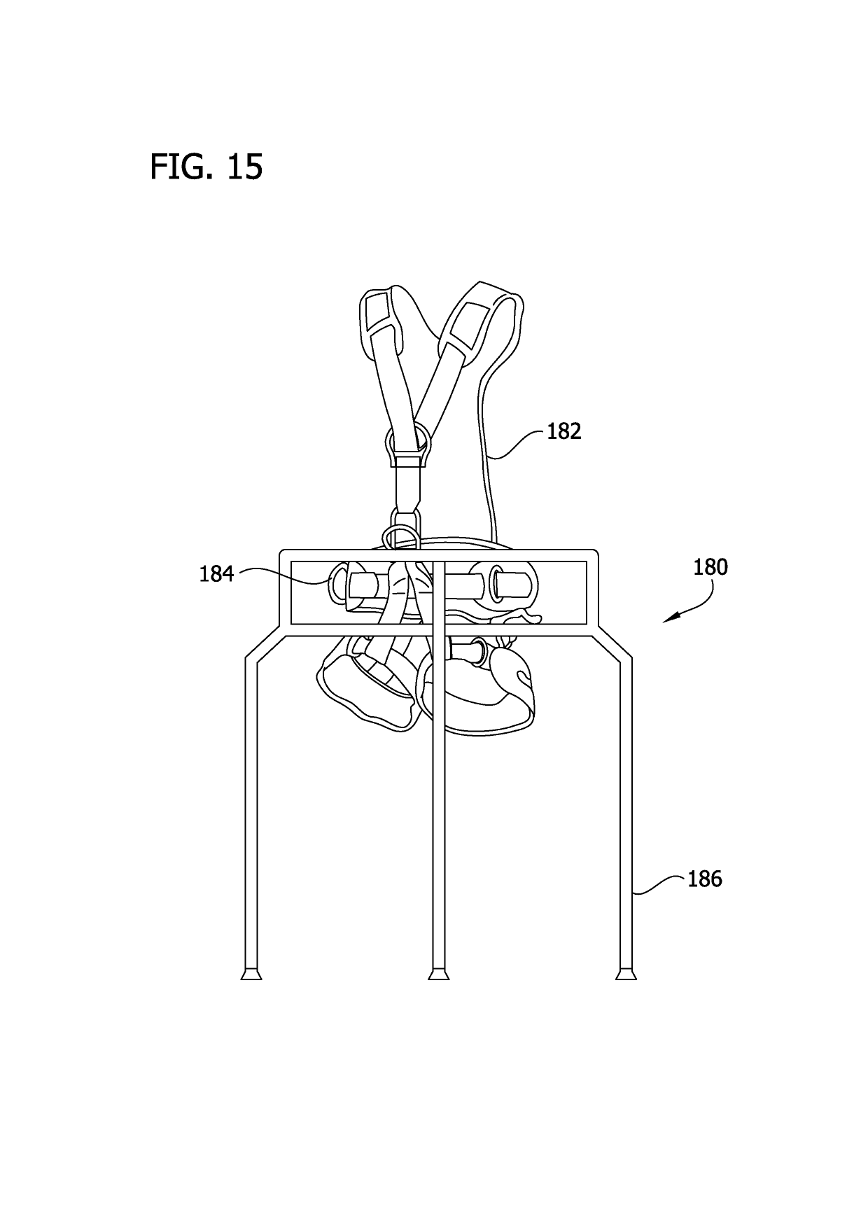

FIG. 15 depicts an alternative embodiment of the physical therapy support device, generally designated by 180, in which the harness assembly 182 includes a belt 184 that is connected to a lower framework 186.

Having described the invention in detail, it will be apparent that modifications and variations are possible without departing from the scope of the invention defined in the appended claims.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A physical therapy support device, comprising:
a framework sized for surrounding a user, the framework having a frame and a plurality of legs extending downward from the frame to casters positioned at lower ends of the legs; and
a harness assembly attached to the frame for suspending a user in the framework, the harness assembly including a leg loop sized for surrounding a leg of the user, and a suspender connected to the leg loop and the frame for suspending the leg loop from the framework to suspend the user inside the framework.

2. A physical therapy support device as set forth in claim 1, wherein the legs of the framework are movable with respect to the frame to change a height of the frame and the harness assembly.

3. A physical therapy support device as set forth in claim 1, wherein the suspenders have an adjustable length to change a height of the harness assembly.

4. A physical therapy support device as set forth in claim 1, wherein the framework comprises a hand support attached to the frame and positioned for grasping by a user positioned in the harness assembly to support at least a portion of a user's weight.

5. A physical therapy support device as set forth in claim 1, wherein the framework comprises a forearm support attached to the frame and for engaging a user's forearm to support at least a portion of a user's weight.

6. A physical therapy support device as set forth in claim 1, wherein the framework comprises a removable seat attached to the frame and positioned to support at least a portion of a user's weight.

7. A physical therapy support device as set forth in claim 1, wherein the harness assembly comprises a torso support sized and shaped for engaging the torso of a user.

8. A physical therapy support device, comprising:
a framework sized for surrounding a user, the framework having a frame and a plurality of legs extending downward from the frame to casters positioned at lower ends of the legs; and
a harness assembly attached to the frame for suspending a user in the framework, the harness assembly including a torso support for surrounding a torso of the user, and a suspender connected to the torso support and the frame for suspending the torso support from the frame to suspend the user inside the framework.

9. A physical therapy support device as set forth in claim 8, wherein the legs of the framework are movable with respect to the frame to change a height of the frame and the harness assembly.

10. A physical therapy support device as set forth in claim 8, wherein the suspenders have an adjustable length to change a height of the harness assembly.

11. A physical therapy support device as set forth in claim 8, wherein the framework comprises a hand support attached to the frame and positioned for grasping by a user positioned in the harness assembly to support at least a portion of a user's weight.

12. A physical therapy support device as set forth in claim 8, wherein the framework comprises a forearm support attached to the frame and for engaging a user's forearms to support at least a portion of a user's weight.

13. A physical therapy support device as set forth in claim 8, wherein the framework comprises a removable seat attached to the frame and positioned to support at least a portion of a user's weight.

14. A physical therapy support device as set forth in claim 8, wherein the torso support comprises a hook and loop fastener sized and shaped for engaging the user's torso.

15. A physical therapy support device as set forth in claim 8, wherein the torso support comprises a body made of flexible material sized and shaped for engaging the user's torso comprising a first end and a second end, and a hook and loop fastener configured to secure the first end to the second end in radial compression around the user's torso.

16. A physical therapy support device as set forth in claim 8, wherein the torso support comprises a cord and pull strap manually tensioned by the user sized and shaped for engaging the user's torso.

17. A physical therapy support device, comprising:
a framework sized for at least partially surrounding a user, the framework having a rectilinear upper frame member, a rectilinear mid frame member connected to the upper frame member, and a plurality of legs extending downward from the mid frame member to casters positioned at lower ends of the legs; and
a harness assembly attached to the upper frame member for suspending a user in the framework, the harness assembly including a user attachment for supporting a user, the user attachment having a leg loop sized for surrounding the leg of a user and a torso support connected to the leg loop for surrounding the torso of a user, and a suspender connected to the torso support and the upper frame for suspending the torso support from the upper frame member to suspend the user inside the framework.

18. A physical therapy support device as set forth in claim 17, wherein the torso support comprises a hook and loop fastener sized and shaped for engaging the user's torso.

19. A physical therapy support device as set forth in claim 17, wherein the torso support comprises a body made of flexible material sized and shaped for engaging the user's torso comprising a first end and a second end, and a hook and loop fastener configured to secure the first end to the second end in radial compression around the user's torso.

20. A physical therapy support device as set forth in claim 17, wherein the torso support comprises a manually tensionable cord for adjusting a size of the torso support.
